(19) United States
(12) Patent Application Publication
(10) Pub. No.: US 2024/0003220 A1
(43) Pub. Date: Jan. 4, 2024

(54) METHOD AND SYSTEM FOR PERMANENTLY REDUCING CARBON DIOXIDE EMISSIONS

(71) Applicant: Carbonpath, Inc., Houston, TX (US)

(72) Inventors: Dan Wrona, Houston, TX (US); Brandon Allen, Houston, TX (US); Sam Arnold, Houston, TX (US); Tyler Crabtree, Houston, TX (US); Matt Steele, Houston, TX (US); Nader Daylami, Houston, TX (US); Erik Baros, Houston, TX (US)

(73) Assignee: Carbonpath, Inc., Houston, TX (US)

(21) Appl. No.: 17/856,141

(22) Filed: Jul. 1, 2022

(51) Int. Cl. E21B 33/13; E21B 47/10

(52) U.S. Cl. CPC E21B 33/13; E21B 47/10

(57) ABSTRACT

A method for permanently reducing carbon dioxide emissions involves determining emission avoidance volumes (EAVs) associated with a hydrocarbon well. The EAVs are based on baseline hydrocarbon reserves determined to be producible from a hydrocarbon reservoir by the hydrocarbon well. The method further involves confirming that the hydrocarbon well is permanently plugged, determining a number of carbon emission avoidance tokens (CEATs) to be issued, based on the EAVs, and issuing the CEATs.

### BACKGROUND

Greenhouse gas emissions are known to contribute to global warming. The oil & gas industry is a significant contributor to greenhouse gas emissions. Efforts to curb greenhouse gas emissions are underway, with the goal of moving towards a carbon neutral footprint.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for permanently reducing carbon dioxide emissions, the method comprising: determining emission avoidance volumes (EAVs) associated with a hydrocarbon well, wherein the EAVs are based on baseline hydrocarbon reserves determined to be producible from a hydrocarbon reservoir by the hydrocarbon well; confirming that the hydrocarbon well is permanently plugged; determining a number of carbon emission avoidance tokens (CEATs) to be issued, based on the EAVs; and issuing the CEATs.

In general, in one aspect, embodiments relate to a system for permanently reducing carbon dioxide emissions, the system comprising: at least one processor configured to: determine emission avoidance volumes (EAVs) associated with a hydrocarbon well, wherein the EAVs are based on baseline hydrocarbon reserves determined to be producible from a hydrocarbon reservoir by the hydrocarbon well, confirm that the hydrocarbon well is permanently plugged, determine a number of carbon emission avoidance tokens (CEATs) to be issued, based on the EAVs and, issue the CEATs.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1A shows a hydrocarbon well environment in accordance with one or more embodiments.

FIG. 1B shows an example of an oil well productivity curve in accordance with one or more embodiments.

FIG. 2 shows a method for reducing carbon dioxide emissions in accordance with one or more embodiments.

FIG. 3 shows a method for determining additionality of a hydrocarbon well in accordance with one or more embodiments.

FIGS. 4A and 4B show permanence polygons for vertical and horizontal wells, respectively, in accordance with one or more embodiments.

FIG. 5A shows an example of a user interface for public viewing, in accordance with one or more embodiments.

FIG. 5B shows an example of a user interface for an operator or hydrocarbon well owner, in accordance with one or more embodiments.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for permanently reducing carbon dioxide emissions. Embodiments of the disclosure primarily focus on an early abandonment of oil and natural gas (hydrocarbon) wells in an environmentally secure manner and keeping CO₂ permanently sequestered in the ground. Embodiments of the disclosure establish a market that enables financial compensation of hydrocarbon well owners that agree to prematurely abandon and plug hydrocarbon wells. More specifically, fungible carbon credits may be issued, thereby providing a financially viable alternative to continued operation of hydrocarbon wells. Simply put, a well owner may be paid for leaving CO₂ in the ground. As a result, embodiments of the disclosure provide a solution that stops climate change pollution at the source—the oil and natural gas wellhead. A detailed description is subsequently provided.

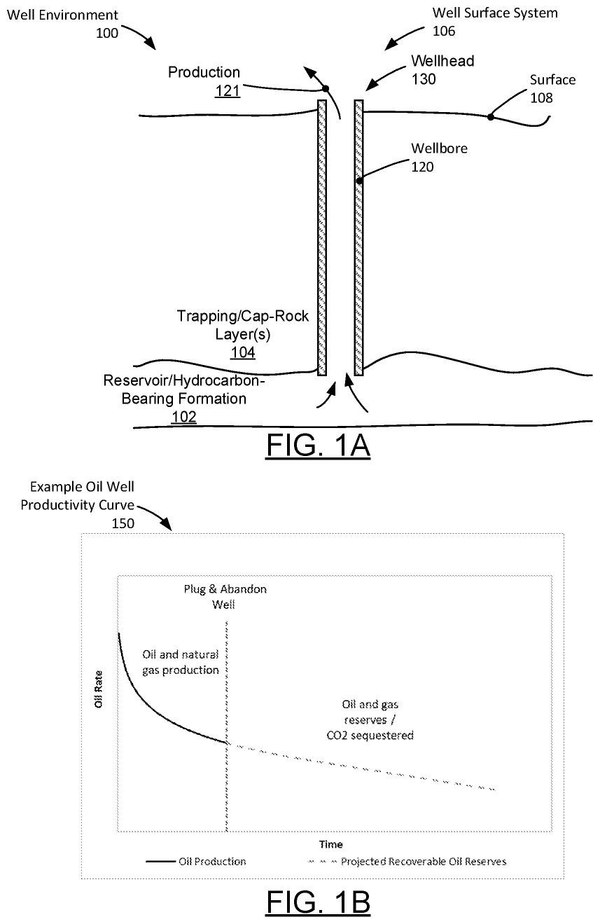

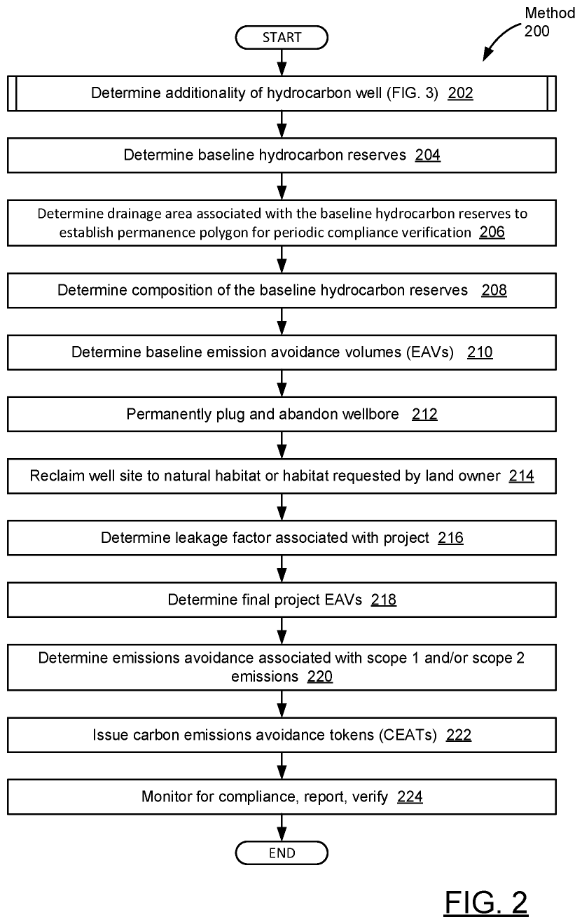

Turning to FIGS. 1A and 1B, FIG. 1A shows a hydrocarbon well environment (100) that includes a hydrocarbon reservoir (“reservoir”) and/or a hydrocarbon-bearing formation (102) capped by trapping and/or cap-rock layers (104) and a well system (106). The hydrocarbon-bearing formation (102) may include a porous or fractured rock formation that resides underground, beneath the earth's surface (“surface”) (108). The hydrocarbon-bearing formation/reservoir (102) may include different layers of rock having varying characteristics, such as varying degrees of permeability, porosity, and resistivity. In the case of the well system (106) being operated as a production well, the well system (106) may facilitate the extraction of hydrocarbons (or “production”) from the reservoir/hydrocarbon-formation (102).

The wellbore (120) may include a bored hole that extends from the surface (108) into a target zone of the reservoir/hydrocarbon-bearing formation (102). An upper end of the wellbore (120), terminating at or near the surface (108), may be referred to as the “up-hole” end of the wellbore (120), and a lower end of the wellbore, terminating in the reservoir/hydrocarbon-bearing formation (102), may be referred to as the “downhole” end of the wellbore (120). The wellbore (120) may facilitate the circulation of drilling fluids during drilling operations, the flow of hydrocarbon production (“production”) (121) (e.g., oil and/or natural gas) from the reservoir/hydrocarbon-bearing formation (102) to the surface (108) during production operations, the injection of substances (e.g., water) into the reservoir/hydrocarbon-bearing formation (102) during injection operations, or the communication of monitoring devices (e.g., logging tools) into the reservoir/hydrocarbon-bearing formation (102) during monitoring operations (e.g., during in situ logging operations).

In some embodiments, the wellbore (120) terminates in a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120). In some embodiments, there are flow regulating devices that are operable to control the flow of substances into and out of the wellbore (120).

While FIG. 1A shows various configurations of components, other configurations may be used without departing from the scope of the disclosure. For example, various components in FIG. 1A may be combined to create a single component. As another example, the functionality performed by a single component may be performed by two or more components.

FIG. 1B shows an example of an oil well productivity curve in accordance with one or more embodiments. Oil and natural gas reservoirs may be underpressured, normally pressured, or overpressured systems that when tapped by a well, may produce rapidly and then diminish over time. Oil and natural gas wells exhibit a predictable production behavior depending on the type of well and the reservoir drive mechanism (i.e., pressure depletion, water drive), as illustrated by the example oil well productivity curve (150).

As the well production declines with depleting pressure, the profitability decreases. However, without incentives, an oil and/or natural gas producer may not feel inclined to ever stop producing, as the marginal cost to produce a well is relatively low after having spent millions of dollars to commission the well, whereas the cost of plugging and abandoning the well may be significant.

One or more embodiments of the disclosure incentivize the well operator to plug and abandon the well. By plugging and abandoning of hydrocarbon wells before the end of their productive life, carbon is left sequestered in the ground that otherwise would have been produced and consumed. The sequestering of hydrocarbon is illustrated in FIG. 1B. At the time indicated by the dashed vertical line, the well is plugged and abandoned. The remaining hydrocarbon reserves are, thus, sequestered. Shutting in oil and natural gas wells and permanently plugging and abandoning them removes significant amounts of carbon from entering the industrial supply chain and atmospheric feedback loop. Embodiments of the disclosure use a carbon credit methodology that encourages the early retirement of producing oil and natural gas wells. A detailed description is subsequently provided.

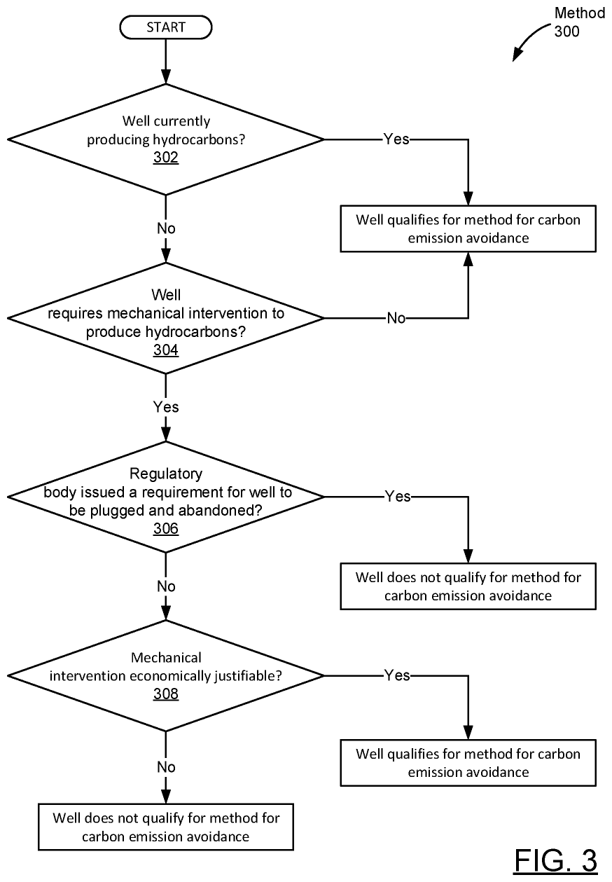

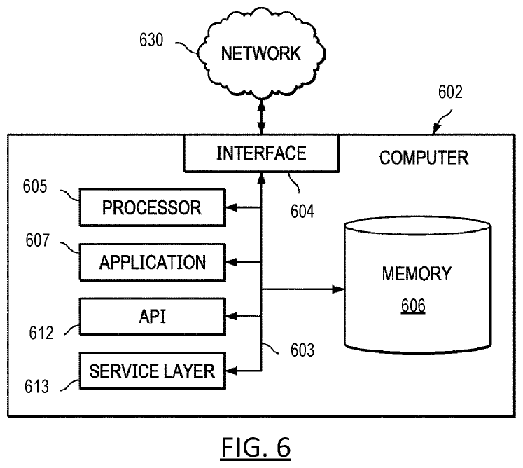

FIG. 2 shows a flowchart of a method for permanently reducing carbon dioxide emissions in accordance with one or more embodiments. While the various steps in FIG. 2 are presented and described sequentially, one of ordinary skill in the art will appreciate that some or all of the blocks may be executed in different orders, may be combined or omitted, and some or all of the blocks may be executed in parallel. Furthermore, the steps may be performed actively or passively. The steps may be performed by one or more computer systems, e.g., computer systems as shown in FIG. 6.

Turning to FIG. 2, the method (200) may be performed for a hydrocarbon well. The method may be separately performed for any number of hydrocarbon wells.

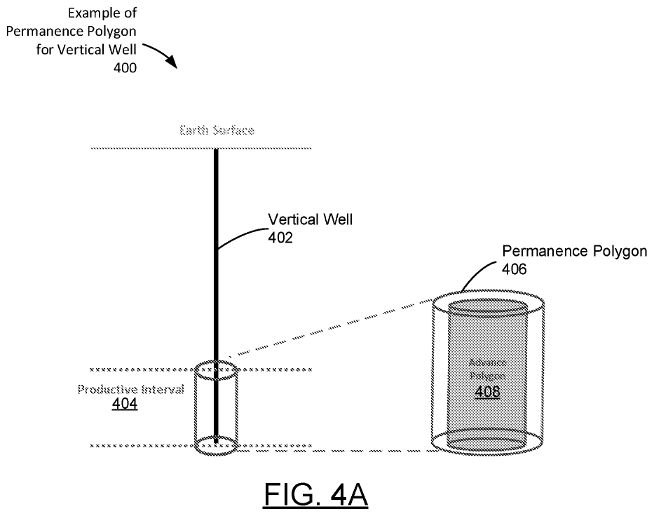

In Step 202, additionality of the hydrocarbon well is determined. Additionality is defined as “a project or activity that reduces greenhouse gas emissions that would not have happened without the offset buyer or collective buyers in the market”. The operator of the hydrocarbon well must justify that the project well or group of wells would not be plugged and abandoned without the incentive from the projected carbon offset credits in accordance with embodiments of the disclosure. In other words, in Step 202, it is to be confirmed that the well or group of wells under consideration for the method (200) is capable of producing hydrocarbons and is not considered a current candidate for plug and abandonment. In most cases, a candidate oil and/or natural gas well for plug and abandonment is one that requires economically unjustifiable mechanical repair in order to return the well to hydrocarbon production or a well that has been identified by a regulatory body as being required to be plugged and abandoned. An economically unjustifiable mechanical repair can range from catastrophic failures such as casing collapse to minor repairs such as a pump change. If the repair is economically unjustifiable, the well becomes a candidate for plug and abandonment. Therefore, the plug and abandonment of a well requiring repair may not qualify as additional and hence cannot receive carbon offset credits under this methodology. A method for determining additionality is described below in reference to FIG. 3.

In Step 204, the baseline hydrocarbon reserves are determined for the well/group of wells under consideration. The baseline hydrocarbon reserves, in one or more embodiments, correspond to the hydrocarbon reserves of a hydrocarbon reservoir that are determined (estimated) to be producible from the hydrocarbon reservoir by the hydrocarbon well. Various different methods, further described below, may be used to determine the baseline hydrocarbon reserves. At least some of these methods may be based on methods standardized and documented by the Society of Petroleum Engineers (SPE). SPE offers standards and documentation for reserves estimating and auditing including the Petroleum Resource Management System (PRMS), the PRMS Application Guidelines, as well as a map to other systems. These standards form the basis of professional reserve audits and is the accepted accounting practice for hydrocarbon resources and reserves.

The assessment of the baseline hydrocarbon reserves in Step 204 may be performed by a hydrocarbon reserves auditing firm that calculates recoverable reserves associated with individual producing wells. The execution of Step 204 may result in the issuance of a reserves certification, an official document—signed and stamped by a third-party, licensed petroleum engineer or geologist—that discloses petroleum reserves, estimated future production profiles and/or cash flows associated with the well/group of wells. These third-party engineering firms present independent reserves certifications to oil and gas companies, governments, and regulatory authorities as well as to banks, law firms, courts, trustees, accountants, and arbiters.

Independent, auditable, and replicable reserves certifications are relied upon by the financial community at large, including commercial, investment, development, and mezzanine banks as well as private investment groups. A reserves certification estimates oil and natural gas in-place quantities and recoverable reserves, future production projections along with the associated income attributable to interests in the subject oil and natural gas fields. The certification may include but is not limited to resources and reserves definitions and calculations, reservoir data, individual well data, field/lease/well production projections and pricing assumptions. The certification may also include financial projections/summaries of gross and net hydrocarbon reserves with the associated income data including discounted net present values and other basic financial data. In some cases, where needed, the certification may include geological descriptions with supporting maps.

In one or more embodiments, when available, an independent third-party hydrocarbon reserves auditing firm must furnish the projected oil and/or natural gas reserves forecast parameters and certify them accordingly. If a third-party hydrocarbon reserves forecast is not available, a probabilistic machine learned tool may be used to produce a P50 oil and/or natural gas reserves forecast. For this methodology, the remaining hydrocarbon reserves shall be defined as the amount of hydrocarbons projected to produce for 25 years beyond the abandonment date, or 1 barrel of oil per day (for predominantly oil wells) or 10 thousand cubic feet (Mcf) per day (for predominantly natural gas wells) whichever comes first. Other values may be used for time and production rate, without departing from the disclosure. The reserves auditor may directly supply and certify the baseline reserves for oil and/or natural gas and the associated drainage area provided the calculations are in compliance with this methodology. If the volume and/or drainage area is not supplied, the wellbore owner may calculate them using the certified parameters as outlined in the following sections.

Oil and/or Natural Gas Well Forecast Volumes

The process of forecasting hydrocarbon reserves may predominantly use a form of production history analysis called decline curve analysis. Decline curve analysis relies on historical oil and/or natural gas production data and the associated producing pressure data to infer and extrapolate a reasonable forecast projection. Two mathematical models can be used to describe the decline curves—hyperbolic decline or exponential decline. These two mathematical models provide a way to represent the current flow regime of a well and are often used in conjunction with one another. As an example, a hyperbolic to exponential decline forecast is widely used for wells producing from what are referred to as unconventional reservoirs.

Hyperbolic Decline Model:

A hyperbolic decline models a decline rate that is not constant but rather changes with time. The producing data plots as a curve on a log y vs x, or semi-log plot. Hyperbolic decline introduces the hyperbolic exponent, or “b” factor, which represents the second derivative of the production rate with respect to time. The value of the b factor represents physical events and processes that can be further expanded upon in many publications by researchers and professional organizations like the SPE. The b factor has no units and generally ranges from 0 to 2. The hyperbolic decline rate is represented as

dₜ=dᵢ/(1+bdᵢt) (Equation 1)

where:
dₜ=nominal decline rate at time, t, =(1/b)*[(1−Dₜ)^{-b}−1]
Dₜ=effective decline rate at time, t
dᵢ=forecast initial nominal decline rate at t=0, =(1/b)*[(1−Di)−b−1]
Dᵢ=forecast initial effective decline rate at t=0
b=hyperbolic exponent.
   The rate, q, at a given time, t, using a hyperbolic decline model is represented as

qₜ=qᵢ/[(1+abt)^{(1/b)]} (Equation 2)

where:
qᵢ=forecasted initial rate, assigns forecast start to be t=0

a=[(1−Dᵢ)^{-b}−1]/b.

The cumulative production, Np, in a given period of time, t, is given as

Np=Term 1*Term 2 (Equation 3)

where:

Term 1=qᵢ/[a*(1−b)]

Term 2=1−(1+abt)^{1-(1/b)}.

Exponential Decline Model:

An exponential decline models a decline rate that is constant. The producing data plots as a straight line on a log y vs x, or semi-log plot. This is the simplest and most conservative mathematical model to represent future production rates. Exponential decline mathematically is a special case of hyperbolic decline where the hyperbolic exponent, b, equals 0. The effective decline rate is represented as

Dₜ=(qᵢ−qₜ)/qᵢ (Equation 4)

where:
Dₜ=effective decline rate at time, t
qᵢ=forecast initial rate, assigns forecast start to be t=0
qₜ=forecast initial rate at time, t
   The rate, q, at a given time, t, using an exponential decline model is represented as

qₜ=qᵢe^{-th} (Equation 5)

where:
d=nominal decline rate (constant) at any time, t, =−ln(1−Dₜ)
qᵢ=forecast initial rate, assigns forecast start to be t=0
   The cumulative production, Np, in a given period of time, t, is given as

Np=(qi−qₜ)/d (Equation 6).

Hyperbolic to Exponential Decline Model:

If used as the lone descriptive decline model, the hyperbolic model tends to overestimate the future production rates due to the shape of the curve becoming smaller over time inherent to the mathematical equation. For this reason, the hyperbolic decline model is often used in conjunction with the exponential decline model to better represent the expected decline later in the life of a well. This is known as a hyperbolic to exponential decline model. The model will convert from hyperbolic decline to the minimum decline rate, or dₘᵢₙ, at some future time, tₕₜₑ. The dₘᵢₙ can be empirically derived from mature wells producing at an exponential decline rate from the same or a similar representative reservoir. Once the hyperbolic decline rate, dₜ, is calculated to be less than dₘᵢₙ, the exponential model is then used to represent the remainder of the forecasted production. Substituting into Equation 1, the time it takes for dₜ<dₘᵢₙ can be calculated as:

tₕₜₑ=Term 3*Term 4 (Equation 7)

where:
tₕₜₑ=point in time when hyperbolic decline turns to exponential decline

Term 3=(1−dₘᵢₙ)^{b}−1+bdₜ

Term 4=bdₜ*[1−(1−dₘᵢₙ)^{b}].

Nominal vs Effective Decline Rate:

The nominal decline rate and the effective decline rate are directly related to one another through the relationship previously provided in the hyperbolic decline model section. From a mathematical standpoint as it relates to hydrocarbon production rates, the nominal decline rate is the slope of the line tangent to a rate at time t, qₜ, while the effective decline rate is slope of a line drawn from the rate at time t, qₜ, back to a reference data point, usually at time zero, or qᵢ.

Calculating the Baseline Hydrocarbon Volumes from Certified Parameters:

Equation 3 may be used to calculate the baseline reserves using hyperbolic decline only, using, for example, t=25 years. To calculate the baseline reserves using exponential decline only, Equation 5 may be used to first calculate qₜ for t=25 years using Equation 5. Then the resulting value and the forecast initial rate (qi) may be used in Equation 6. To calculate the baseline reserves using a hyperbolic to exponential decline, first tₕₜₑ may be determined from Equation 7. For t<tₕₜₑ and, for example, t≤25 years from plugging and abandonment, the cumulative production is calculated by a combination of equations listed previously. To determine the cumulative production associated with the hyperbolic decline portion of the forecast, tₕₜₑ may be used in the hyperbolic decline cumulative production equation (Equation 3). Next, the rate at which the hyperbolic decline portion of the forecast ends may be determined using tₕₜₑ in Equation 2. This calculated rate may be substituted into Equation 5 for qᵢ as well as t=25−tₕₜₑ to determine the final rate of the exponential portion of the forecast at a total time of 25 years. Subsequently, the final rate of the hyperbolic decline portion may be substituted as qᵢ and the final rate of the exponential decline portion of the forecast as qₜ in Equation 6 to determine the cumulative production associated with the exponential decline portion of the forecast. In order to compute the baseline reserves, the cumulative production for each portion of the forecast, the hyperbolic and exponential may be combined.

In Step 206, the drainage area associated with the baseline hydrocarbon reserves is determined to establish a permanence polygon for periodic compliance verification.

Permanence in sequestering carbon is the key to making meaningful climate impacts. If the activity is not permanent, the carbon dioxide may be displaced to another point in time and the impact is nullified. Therefore, embodiments of the disclosure establish what shall be known as a permanence polygon. A polygon may be established around each qualifying oil and/or natural gas well and may serve to ensure the permanence of the carbon being sequestered using the described method. The permanence polygon may be defined by the drainage area associated with the baseline hydrocarbon reserves for the productive interval of each well or group of wells. Inherent within the permanence polygon shall be the advance polygon that represents the drainage area associated with the advance emissions avoidance volumes (advance EAVs) as outlined below in the description of Step 218. One may determine a drainage area at a future time given the projected reserves from these third-party calculations, the volume of hydrocarbons produced to date, and the volume of hydrocarbons originally present.

Calculating Original Hydrocarbon in Place Per Unit Area:

Estimating hydrocarbon reserves is a complex process that involves geologic, petrophysical and engineering data. The Petroleum Resources Management System (PRMS) outlines the standards by which original hydrocarbon in place is calculated and is therefore adhered to by independent hydrocarbon reserves auditors. The amount of original hydrocarbon in place per unit area is based on the vertical thickness of the productive interval, the porosity of the rock through which the hydrocarbons will flow and the initial hydrocarbon saturations in those pore spaces. These geologic parameters have been exhaustively studied and can be measured using standardized techniques employing modern technology.

Original Hydrocarbon in Place/Area=hΦbSₒ/Bₒᵢ (Equation 8a)

### [Predominantly Oil Well]

Original Hydrocarbon in Place/Area=hΦS_{g}/B_{gi} (Equation 8b)

### [Predominantly Natural Gas Well]

where:

Original Hydrocarbon in Place is in Surface Barrels of Oil or Surface ft³ of Natural Gas
Area is in ft²
h=vertical thickness of productive interval (ft)
Φ=porosity of the rock (decimal)
Sₒ=initial oil saturation (decimal)
S_{g}=initial gas saturation (decimal)
Bₒᵢ=formation volume factor for oil (reservoir barrels/surface barrels), measured in a laboratory
B_{gi}=formation volume factor for natural gas (reservoir ft³/surface ft³), measured in a laboratory.

Not all of the original hydrocarbon in place may be recoverable due to physical limitations. A certain percentage of the hydrocarbon in place is deemed recoverable and is commonly referred to as the recovery factor (RF). This recovery factor is based on the rock properties in which the hydrocarbon resides, the fluid properties of the hydrocarbons and associated water as well as the mechanism by which the fluids are being produced. These recovery factors have been studied for decades and reasonable ranges based on producing mechanism are made publicly available through SPE and its partners. Hydrocarbon reserves auditing firms are astutely aware of these reasonable ranges and apply them in their evaluations. Recoverable hydrocarbon in place is calculated as:

Recoverable Hydrocarbon in Place/Area=RF×Original Hydrocarbon in Place/Area (Equation 9)

For this methodology, the upper end of the American Association of Petroleum Geologists (AAPG) published recovery factor range by producing mechanism shall be used and are stated in the table below.

TABLE 1
Primary recovery factor for different producing mechanisms

| Producing Mechanism | Primary Recovery Factor (RF) (%) |
|---|---|
| Depletion | |
| Solution Gas | 25 |
| Expansion | 5 |
| Gas Cap Drive | 40 |
| Water Drive | |
| Bottom | 40 |
| Edge | 60 |
| Gravity | 70 |

Once the recoverable hydrocarbon in place per unit area is determined, the drainage area may be calculated using simple geometric shapes. The geometry, and thus the drainage area calculation, is dependent on the type of well, vertical or horizontal. A vertical well is defined as a borehole into the ground with slight deviation in the vertical direction, into the Earth. A horizontal well is defined as a borehole into the ground that has a vertical component as well as a component that is drilled at or near a 90-degree angle to the vertical.

Calculating Drainage Area from a Vertical Well:

The assumed drainage geometry of a vertical well is that of a cylinder with height, h, and a radius, r. The height, as previously defined, is the vertical thickness of the productive interval and is incorporated into the recoverable hydrocarbon per unit area in equation 9. The radius can then be calculated using the following equation:

πr2=Baseline Reserves/(Recoverable Hydrocarbon in Place/Area) (Equation 10a)

rearranged

r=[Baseline Reserves/(Recoverable Hydrocarbon in Place/Area)/π]^{1/2} (Equation 10b).

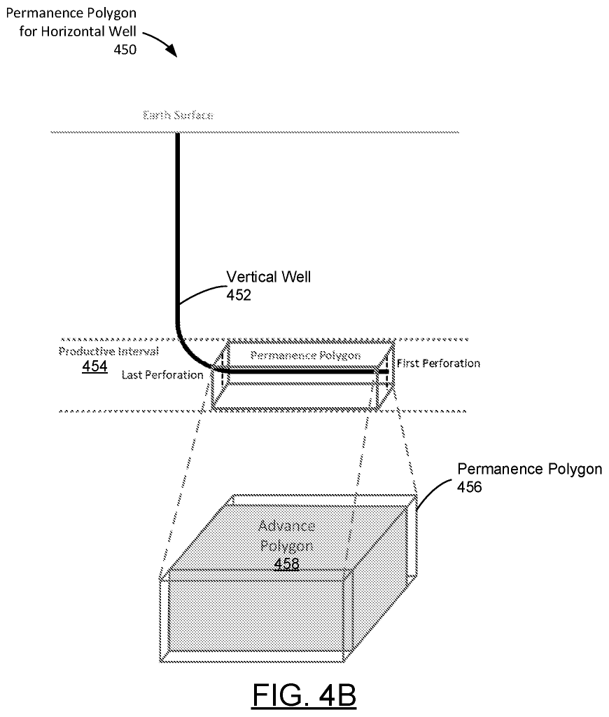

The permanence polygon, a cylinder, is thus established. The depth of the top of the cylinder shall be defined as the point at which the wellbore enters the productive interval. An illustration of the permanence polygon for a vertical well is provided in FIG. 4A.

Calculating Drainage Area from a Horizontal Well:

The assumed drainage geometry of a horizontal well is that of a rectangular block of height, h, length, l, and width, w. The height, as previously defined, is the vertical thickness of the productive interval and is incorporated into the recoverable hydrocarbon per unit area in equation 9. The length of the rectangular block is the length of the lateral portion of the wellbore which shall be defined as distance between the first and last perforation in the wellbore. Perforations are access points in/along the casing of a wellbore that allow fluid flow from the reservoir to the wellbore to be produced. The width can therefore be calculated using the following equation:

width=[Baseline Reserves/(Recoverable Hydrocarbon in Place/Area)]/length (Equation 11)

The permanence polygon, a rectangular block, is thus established. The depth of the rectangular block shall be defined as top depth of the productive interval along the lateral portion of the wellbore.
In one or more embodiments, the permanence polygon is created in a geographic information system (GIS) that facilitate the compliance monitoring of Step 224, described below.

In Step 208, the composition of the baseline hydrocarbon reserves is determined. Oil and natural gas, by their nature, have different chemical compositions with varying levels of hydrocarbon components. The hydrocarbons vary in length and complexity. Oil and natural gas reservoir fluid can be evaluated in chemistry laboratories through standard and verifiable methods such as chromatography or mass spectroscopy. An independent third-party may evaluate the chemical composition. Multiple independent third-party chemical laboratories can perform crude oil and natural gas analysis to ascertain the exact composition. It is preferred that a chemical composition analysis be performed on the subject well for purposes of calculating the CO₂ associated with a given hydrocarbon volume. If a chemical composition from the subject well is not readily available, a chemical composition from a nearby representative well producing hydrocarbons from the same reservoir may be acceptable.

To initially estimate the project CO₂ equivalents (CO₂e) from crude oil and natural gas, the US Environmental Protection Agency (EPA) has published the Greenhouse Gases Equivalencies Calculator—Calculations and References (https://www.epa.gov/energy/greenhouse-gases-equivalencies-calculator-calculations-and-references). According to the EPA, the average carbon dioxide emissions equivalent per barrel of crude oil produced in the US is 0.43 metric tons CO₂/barrel while the average carbon dioxide emissions equivalent per thousand cubic feet (Mcf) of natural gas is 0.0548 metric tons CO₂/Mcf. Once a chemical composition analysis is obtained, the following outlines the steps to determine the carbon dioxide emissions equivalent for a project.

A chemical analysis of crude oil may include the specific gravity at 60° F. which is a dimensionless quantity that is calculated as the density of the fluid being analyzed relative to the density of water. Taking the specific gravity and multiplying by the density of water at 60° F. (997 kg/m³) yields the density of the crude oil. Given that crude oil is most often measured in barrels (bbl) in the US, converting the density of the crude oil to kg/bbl is as simple as applying the following conversion factors: 42 US gallons/bbl, 264.172 US gallons/m³. Using molecular weight, liquid hydrocarbons have a carbon content range of 83% (pentane) to 95% (pyrene) with the median of all potential liquid hydrocarbons being 85.6%. The described methodology may use that median for the calculation of carbon content. The median carbon content for liquid hydrocarbons (85.6%) may be multiplied with the crude density in kg/bbl to yield the carbon density of the crude oil that will be associated with carbon dioxide formation (kg C/bbl). Using the generic hydrocarbon combustion formula, Hydrocarbon Fuel+O₂→CO₂+H₂O, next the carbon density may be converted to carbon dioxide density by multiplying by the ratio of molecular weights for that of CO₂ relative to carbon (44 g CO₂/mol÷12 g C/mol=3.6667). Then, the result may be divided by 1000 to convert kg CO₂ equivalent (CO₂e) to metric tons CO₂e and the result is the specific conversion factor for the crude oil of the project in MTCO₂e/bbl.

The CO₂e conversion factor for natural gas may be very similar to that of crude oil with only slight differences. Natural gas specific gravity is reported relative to air instead of water. Taking the specific gravity and multiplying by the density of air at 60° F. (1.205 kg/m 3) yields the density of the natural gas. Given that natural gas is most often measured in thousands of cubic feet (Mft³ or Mcf) in the US, converting the density of the natural gas to kg/Mcf is as simple as applying the conversion factor from m³ to Mcf (0.0353147 Mcf/m³). Next, the carbon content of the natural gas may be determined. The chemical composition of pipeline natural gas is comprised largely of saturated hydrocarbons, or ones with only single carbon to carbon bonds. Due to this fact, a regression analysis can be performed on the relationship between natural gas specific gravity and the carbon content of saturated hydrocarbons from methane to butane. Based on the regression analysis, it may be determined that specific gravity and carbon content can be represented by a logarithmic relationship with a very strong fit (R²>97%).

Therefore, the methodology in accordance with embodiments of the disclosure uses this logarithmic relationship (% Carbon=0.0612*ln (Specific Gravity)+0.7886) to determine the natural gas carbon content for each project. Multiplying the carbon content by the natural gas density in kg/Mcf yields the carbon density of the natural gas that will be associated with carbon dioxide formation (kg C/Mcf). Using the generic hydrocarbon combustion formula, Hydrocarbon Fuel+O₂→CO₂+H₂O, the carbon density may be converted to carbon dioxide density by multiplying by the ratio of molecular weights for that of CO₂ relative to carbon (44 g CO₂/mol÷12 g C/mol=3.6667). The result may be divided by 1000 to convert kg CO₂ equivalent (CO₂e) to metric tons CO₂e and the result is the specific conversion factor for the natural gas of the project in MTCO₂e/Mcf.

In Step 210, The baseline emission avoidance volumes (EAVs) are determined. To determine the baseline EAVs, the baseline hydrocarbon reserves (obtained in Step 204) may be multiplied by the CO₂ associated within a given fluid volume (obtained in Step 208) for oil and/or natural gas. The resultant quantity or combined quantity is the CO₂ equivalent volumes associated with the hydrocarbon reserves volume and the project baseline emissions avoidance volumes that are permanently sequestered.

In Step 212, the wellbore is permanently plugged and abandoned. Plugging and abandonment of hydrocarbon wells is a long accepted and government regulated process for the permanent sequestration of hydrocarbon reserves. In one or more embodiments of the disclosure, the governing body that oversees the operation of the project wellbore(s), be it a state or federal government or entity thereof, certifies that the wellbore has been plugged and abandoned. The certification may be public.

The plugging and abandonment of an oil and/or natural gas well may include one or more of the following:
a. Preparation of the well site for abandonment activities. Precautions may be taken to ensure the well is safe to work around. The site may be assessed to ensure safe access and egress, soil condition and stability, contour of terrain, presence of plants and/or animals, potentially hazardous atmospheres near the well, traffic and movement, equipment staging and other hazards at the site.
b. Removal and salvaging available wellbore casing, tubulars, and other equipment. Tubulars may be removed through the process of freepoint/backoff, stretching, or by simply cutting off the tubulars at a predetermined depth using chemical cutting, explosives, hydraulic cutting, or pulling methods.
c. Removal of free and stuck tubulars above the cut using fishing tools. Tubulars below the cut may be left in the wellbore.
d. Placement of cement plugs in the wellbore and extensive testing to prevent migration of fluids between different formations. Plugging, in one or more embodiments, is subject to federal and state regulations. Regulations may vary from state to state and country to country.
e. Cutting of upper casing below grade and plugging the well before the surface is reclaimed to match the surrounding environment. Reclaiming activities may be subject to federal and state environmental regulations. Regulations may vary from state to state and country to country.

In Step 214, the well site may be reclaimed to natural habitat or habitat requested by the landowner. Step 214 may be optional. Outside of returning the wellsite to the natural habitat, other environmentally positive actions such as installing solar panels, installing wind turbines, etc., could increase the impact of the CO₂ reductions but are not necessarily required.

In Step 216, the leakage factor associated with the project is determined. The leakage factor (LF), or the disposition factor for another entity to replace some or all of the hydrocarbon production being permanently sequestered, may be calculated as follows:

### Predominantly Oil Well:

LF=Project Oil Production Rate/Principality Oil Production Rate (Equation 12)

### Predominantly Natural Gas Well:

LF=Project Natural Gas Production Rate/Principality Natural Gas Production Rate (Equation 13)

The leakage factor range may be from 0 to 1 and shall be applied to all project emissions avoidance volumes. The project production rate shall be deemed as the production rate at the time of abandonment, or the most recent available rate for wells not currently producing hydrocarbons. For wells in the United States, the US Energy Information Administration (EIA) publishes the current production rates by state, updated monthly. Embodiments of the disclosure may use the most recent data available from the EIA (https://www.eia.gov/petroleum/production/#ng-tab), (https://www.eia.gov/petroleum/production/#oil-tab). The published data may be used for the principality oil/natural gas production rate in the United States. Other available data may be used in other parts of the world, without departing from the disclosure.

In Step 218, the final project EAVs are determined. Determining the final project EAVs may involve determining advance EAVs and buffer pool EAVs, as subsequently discussed.

The advance emissions avoidance volumes (advance EAVs) shall be defined as, for example, no more than the first 10 years of the baseline EAVs. If the life of the project baseline EAVs as defined above is greater than 10 years, the advance EAVs may be defined as follows:

Advance EAVs=Baseline EAVs (t≤10 years)×(1−Leakage Factor) (Equation 14a)

If the life of the project baseline EAVs as defined above are less than 10 years, the advance EAVs shall constitute 80% of the baseline EAVs.

Advance EAVs=Baseline EAVs (t≤10 years)×(1−Leakage Factor)×0.80. (Equation 14b)

The buffer pool EAVs shall be defined as the remaining baseline EAVs not captured in the advance EAVs. The buffer pool EAVs shall be held in reserve if an unforeseen encroachment and subsequent production of hydrocarbons occurs from an established permanence polygon. The buffer pool EAVs are defined as:

Buffer Pool EAVs=[Baseline EAVs×(1−Leakage Factor)]−Advance EAVs. (Equation 15)

In Step 220, the emissions avoidance associated with scope 1 and/or scope 2 emissions are determined. There are a variety of scope 1 and scope 2 emissions avoidance that may qualify for carbon credits. The following scope 1/scope 2 emissions avoidances may be accepted:
Avoided electricity consumed (if on grid power),
Avoided electricity generated (if not on grid power and not using lease natural gas as generator fuel),

The emissions avoidances may be calculated as follows:
Avoided electricity consumed (adapted from “Home electricity use” formula): 4.635×10-4 metric tons CO2/kWh
Avoided electricity generated (gasoline): 8.887×10-3 metric tons CO2/gallon of gasoline.
Avoided electricity generated (diesel): 10.180×10-3 metric tons CO2/gallon of diesel.

The greenhouse gas (GHG) emissions calculated of the EPA may be used to perform these calculations.

The project developer may provide documentation that substantiates the quantities to be used in each calculation. The EAVs from scope 1/scope 2 shall be defined as those avoided for a period of 12 months following the verified plug and abandonment of the wellbore. The leakage factor shall be applied to these volumes just as it is for advance and buffer pool EAVs. All volumes shall be additive to the advance EAVs. Step 220 may be optional.

In Step 222, carbon emissions avoidance tokens (CEATs) are issued. Once the advance, buffer pool, and scope 1/scope 2 EAVs have been calculated, all volumes may be required to be certified, and all associated documentation provided may be required to be verified and validated.

One CEAT may be issued for each ton of CO₂ equivalent. Each CEAT may be a unique non-fungible token (NFT) that is immutable and may be living on the Celo blockchain (e.g., utilizing the ERC721 standard or any other standard) or any other blockchain. In one or more embodiments, the NFTs may be converted to a fungible token. In one or more embodiments, some tokens are placed into an active status associated with the Advance Emission Avoidance Volumes (Advance EAVs), while others may be placed into an inactive status. The inactive fungible tokens associated with the Buffer Pool Emission Avoidance Volumes (Buffer Pool EAVs) may act as the buffer, or insurance policy, in the case of future encroachment on a plugged and abandoned well's hydrocarbon reserves and thus carbon credits. The advance EAVs and buffer pool EAVs may have been determined by the operations of Step 218. Similarly, a fungible token may also be generated for a scope 1 EAVs. The fungible token may represent the asset value of one ton of CO₂ equivalent sequestered or any other amount. The fungible token may then be sold and/or retired by the generator of the credit. A fungible token may be retired for the well owner's own purposes or held on the balance sheet of an individual or entity for expected future emissions and retired when needed. The fungible tokens may be based upon the ERC-20 standard, so that they may be traded on the Ethereum blockchain, e.g., at a token exchange. Other current or future blockchain standards and technologies may be used, without departing from the disclosure.

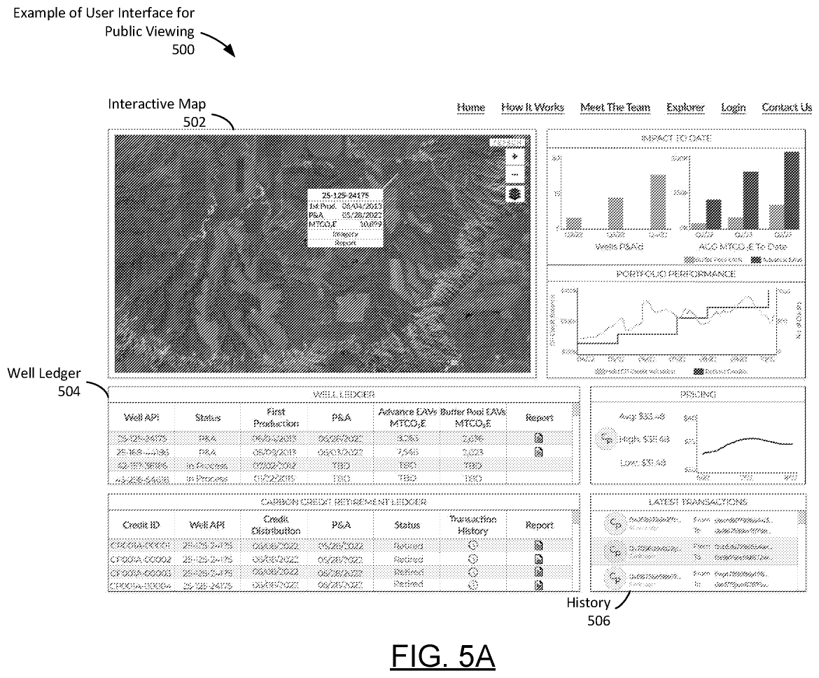

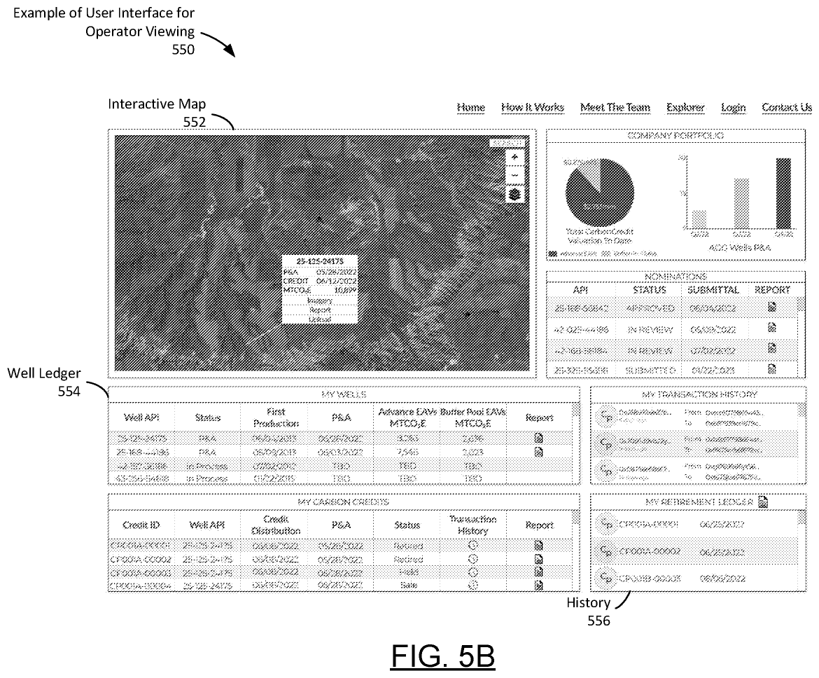

In Step 224, the hydrocarbon reserves associated with the CEATs and the permanence polygon are continuously monitored and verified while being reported on periodically, e.g. on a private or public website as illustrated in the examples of FIGS. 5A and 5B. Various technologies may be used to aggregate data from states and federal governments to perpetually assess the integrity of the permanence polygon and ensure the permanence of the carbon being sequestered. For example, state and county databases may be reviewed, drone footage and satellite images may be analyzed, etc. Machine learning-based image processing may be used to analyze the obtained data for features such as wellbores, tanks, etc. In one or more embodiments, various inputs (e.g., third party inputs) may be used to monitor the permanence polygon in a geographic information system (GIS). These third-party inputs may indicate, for example, where new wells are being drilled, and the type of wells (e.g., horizontal or vertical) that are being drilled. A crossing into the permanence polygon may, thus, be detected. Any future oil and/or natural gas wellbore encroachment inside the established permanence polygon but not within the advance polygon within the defined productive interval shall negate all buffer pool EAVs, determined in Step 218, for the well or group of wells. Any future oil and/or natural gas wellbore encroachment inside the established advance polygon within the defined productive interval shall negate all advance and buffer pool EAVs for the well or group of wells.

FIG. 3 shows a method (300) to determine additionality, in accordance with one or more embodiments. A series of tests may be performed to determine whether additionality exists for the hydrocarbon well under consideration.

In Step 302, it is determined whether the well is currently producing hydrocarbons. If the well produces hydrocarbons, additionality is confirmed, and the well does qualify for the disclosed method for carbon emission avoidance. If the well does not produce hydrocarbons, additional tests may need to be performed to determine whether there is additionality.

In Step 304, it is determined whether the well requires mechanical intervention (e.g., repairs) to produce hydrocarbons. If no intervention is needed, additionality is confirmed, and the well does qualify for the disclosed method for carbon emission avoidance. Otherwise, additional tests may need to be performed to determine whether there is additionality.

In Step 306, it is determined whether a regulatory body issued a requirement for the well to be plugged and abandoned. If such a requirement was issued, the well does not qualify for the disclosed method for carbon emission avoidance. Otherwise, additional tests may need to be performed to determine whether there is additionality.

In Step 308, it is determined whether the mechanical intervention that is needed is economically justifiable. If the mechanical intervention is economically justifiable, then the well does qualify for the disclosed method for carbon emission avoidance. Otherwise, the well does not qualify for the disclosed method for carbon emission avoidance.

FIG. 4A shows an example of a permanence polygon for a vertical well in accordance with one or more embodiments. In the example (400), a vertical well (402) is used to access a productive interval (404). In the productive interval (404), the assumed drainage geometry is that of a cylinder with height, h, and a radius, r. The height, as previously defined, is the vertical thickness of the productive interval (404). The radius may be calculated as described above in the discussion of Step 206. The permanence polygon (406), a cylinder, is thus established. The depth of the top of the cylinder shall be defined as the point at which the wellbore enters the productive interval (404). FIG. 4A further shows an advance polygon (408) within the permanence polygon (406). The advance polygon represents the drainage area associated with the advance EAVs.

FIG. 4B shows an example of a permanence polygon for a horizontal well in accordance with one or more embodiments. In the example (450), a horizontal well (452) is used to access a productive interval (454). The assumed drainage geometry of a horizontal well is that of a rectangular block of height, h, length, l, and width, w, forming the permanence polygon (456). The height, as previously defined, is the vertical thickness of the productive interval (454). The length of the rectangular block is the length of the lateral portion of the wellbore which shall be defined as distance between the first and last perforation in the wellbore. Perforations are access points in/along the casing of a wellbore that allow fluid flow from the reservoir to the wellbore to be produced. The width may be calculated as described in the discussion of Step 206. FIG. 4B further shows an advance polygon (458) within the permanence polygon (456). The advance polygon represents the drainage area associated with the advance EAVs.

FIG. 5A shows an example of a user interface (500) for public viewing, in accordance with one or more embodiments. The publicly accessible portal may help ensure transparency, provide education, analysis and validation, thereby help establish trust. The user interface (500) includes an interactive map (502), a well ledger (504), and a history (506).

The interactive map (502) may be used to visualize the wells, including wells that have been plugged and abandoned in accordance with embodiments of the disclosure, wells that are under consideration for early abandonment, and/or producing wells. The interactive map (502) may provide zoom and/or pan functionality for navigation. The interactive map (502) may further allow selection of wells to obtain additional details specific to the selected wells.

The well ledger (504) may display available information related to wells (e.g., wells displayed in the interactive map (502)). The additional information may be presented in table format and may contain various details, as shown in the example of FIG. 5A.

The history (506) may provide information on the market of fungible tokens. For example, the most recent transactions may be shown. In addition, the pricing of a fungible token in another currency (e.g., US$) may be shown.

Other information provided in the user interface (500) may include, but is not limited to, an environment impact that has been achieved. For example, a summary of wells that have been plugged and abandoned in accordance with embodiments of the disclosure may be shown. Further, both advance EAVs and buffer EAVs may be displayed. In one embodiment, the user interface (500) also includes a carbon credit retirement ledger that shows how EAVs have been used to offset ongoing carbon emissions.

FIG. 5B shows an example of a user interface (550) for an operator or hydrocarbon well owner, in accordance with one or more embodiments. The operator-accessible portal may provide detailed information about the operator's projects and may facilitate nomination and/or sales of additional projects. The user interface (550) includes an interactive map (552), a well ledger (554), and a history (556).

The interactive map (552) and the well ledger (554) may be substantially similar to the corresponding elements described in reference to FIG. 5A.

The history (556) may provide information on transactions made by the operator. For example, the most recent transactions involving fungible tokens may be shown. In addition, a retirement ledger may show how EAVs have been used to offset ongoing carbon emissions.

Other information provided in the user interface (500) may include, but is not limited to, a display of the operator's portfolio. The display of the portfolio may be structured to show advance EAVs and buffer pool EAVs. Further, nominations of wells considered for early plugging and abandonment may be shown in a table, including their current status.

Embodiments disclosed herein may be implemented on a computer system. FIG. 6 is a block diagram of a computer system (602) used to provide computational functionalities associated with described algorithms, methods, functions, processes, flows, and procedures as described in the instant disclosure, according to an implementation. The illustrated computer (602) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

In some embodiments, the computer (602) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Embodiments of the disclosure have one or more of the following advantages. Embodiments of the disclosure establish a true market for carbon, thereby incentivizing market solutions to tackle climate change at an increased pace.

Embodiments of the disclosure are highly scalable and impactful. For example, if this methodology is applied to the more than 400,000 wells in the United States that are actively producing 1-15 barrels of oil equivalent per day (boepd), 1.4 million boepd would be removed from production which is the approximate equivalent of 500,000 tons of CO₂ per day. Applied globally to any wells around the world producing oil and natural gas, the opportunity would be 5-7× greater than the U.S. domestic opportunity alone. Removing 450,000 tons of CO₂ per day is the equivalent of preserving 1.1 million acres of forest (the size of the Sequoia National Forest in California) every day or removing 35 million cars from the road each day according to the EPA.

Embodiments of the disclosure guarantee that carbon offsets are real: Carbon credits are only issued upon project completion when plug and abandonment certifications are received from the applicable governmental regulatory bodies.

Embodiments of the disclosure guarantee that carbon offsets are permanent: Once wells have been properly plugged and abandoned (P&A), market prices approaching $1000/barrel of oil would be required for another operator to access those hydrocarbon reserves.

Embodiments of the disclosure guarantee that carbon offsets are quantifiable: There are scientific equations based on the chemical properties of oil and natural gas that determine the carbon dioxide equivalent. The Environmental Protection Agency estimates this at 0.43 tons of CO₂ per barrel of oil for a typical barrel of oil produced in the US.

Embodiments of the disclosure guarantee that carbon offsets are additional: Without the carbon credit financial incentive, the oil producer would continue to produce oil out of the well or sell it to someone who would until it reaches the end of its productive life (often <1 barrel of oil per day).

Embodiments of the disclosure are secure, as a result of using a proof of stake consensus mechanism associated with a blockchain to create a unique non-fungible token (NFT) that is then burned and minted into an ERC-20 token on the Celo (or other) blockchain. One token may represent one ton of carbon dioxide removed thereby preserving the unique nature, open transparency, and avoidance of any fraud for the credits while allowing them to be bought and sold as a fungible token.

Operations performed in accordance with embodiments of the disclosure are verifiable: A two-step independent review of the oil and natural gas reserves and their carbon dioxide equivalency impact may be used for each project by reputable and experienced 3rd party petroleum reserves auditors and chemical laboratories.

Embodiments may further provide various co-benefits. For example, embodiments of the disclosure may reduce the problem of abandoned and orphaned wells and long-term methane leaks. Embodiments of the disclosure may reduce emissions avoided with well servicing required by active wells. Embodiments of the disclosure may allow for recycling of steel and other resources from the well site. Embodiments of the disclosure may help provide potential carbon sinks on former well sites. Embodiments of the disclosure may provide opportunity for creating alternative energy development on former well sites.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A method for permanently reducing carbon dioxide emissions, the method comprising:
determining emission avoidance volumes (EAVs) associated with a hydrocarbon well,
wherein the EAVs are based on baseline hydrocarbon reserves determined to be producible from a hydrocarbon reservoir by the hydrocarbon well;
confirming that the hydrocarbon well is permanently plugged;
determining a number of carbon emission avoidance tokens (CEATs) to be issued, based on the EAVs; and
issuing the CEATs.

2. The method of claim 1, further comprising:
determining an additionality of permanently plugging the well to confirm that plugging the well does reduce carbon dioxide emissions.

3. The method of claim 1, further comprising:
determining the baseline hydrocarbon reserves using one selected from a group consisting of a hyperbolic decline model, an exponential decline model, and a hyperbolic to exponential decline model.

4. The method of claim 3, wherein the baseline hydrocarbon reserves are determined for 25 years from the date when the hydrocarbon well is permanently plugged.

5. The method of claim 1, further comprising:
after permanently plugging the hydrocarbon well, monitoring the baseline hydrocarbon reserves for compliance to ensure permanence.

6. The method of claim 5, wherein monitoring the baseline hydrocarbon reserves comprises determining a drainage area associated with the baseline hydrocarbon reserves.

7. The method of claim 6, wherein determining the drainage area associated with the baseline hydrocarbon reserves comprises determining a permanence polygon, and wherein the permanence polygon comprises one selected from the group consisting of
a vertically oriented cylinder for the hydrocarbon well being a vertical well, and
a rectangular block for the hydrocarbon well being a horizontal well.

8. The method of claim 7, further comprising, when detecting encroachment into the permanence polygon:
negating buffer pool EAVs of the CEATs.

9. The method of claim 7, wherein monitoring the baseline hydrocarbon reserves further comprises determining a drainage area associated with EAVs over a set time interval using an advance polygon inside the permanence polygon.

10. The method of claim 9, further comprising, when detecting encroachment into the advance polygon:
negating all CEATs.

11. The method of claim 1, further comprising:
determining a composition of the baseline hydrocarbon reserves representing a CO₂ equivalent (CO₂e) associated with a given volume of the baseline hydrocarbon reserves; and
determining baseline EAVs by multiplying the baseline hydrocarbon reserves with the composition of the baseline hydrocarbon reserves.

12. The method of claim 11, further comprising:
correcting the baseline EAVs for a leakage factor.

13. The method of claim 12, further comprising:
determining advance EAVs by discounting the baseline EAVs using the leakage factor, for a set time interval; and
using the advance EAVs as the EAVs for determining the number of CEATs to be issued.

14. The method of claim 13, further comprising:
determining buffer pool EAVs by subtracting the advance EAVs from the baseline EAVs; and
reserving the buffer pool EAVs as an insurance against unforeseen encroachment into the baseline hydrocarbon reserves.

15. The method of claim 14, wherein the CEATs are non-fungible tokens.

16. The method of claim 15, further comprising:
converting the CEATs to fungible tokens; and
providing the fungible tokens to an owner of the hydrocarbon well.

17. A system for permanently reducing carbon dioxide emissions, the system comprising:
at least one processor configured to:
determine emission avoidance volumes (EAVs) associated with a hydrocarbon well,
wherein the EAVs are based on baseline hydrocarbon reserves determined to be producible from a hydrocarbon reservoir by the hydrocarbon well,
confirm that the hydrocarbon well is permanently plugged,
determine a number of carbon emission avoidance tokens (CEATs) to be issued, based on the EAVs and,
issue the CEATs.

18. The system of claim 17, wherein the at least one processor is further configured to:
after permanently plugging the hydrocarbon well, monitor the baseline hydrocarbon reserves for compliance to ensure permanence.

19. The system of claim 17, wherein the at least one processor is further configured to:
determine a composition of the baseline hydrocarbon reserves representing a CO₂ equivalent (CO₂e) associated with a given volume of the baseline hydrocarbon reserves; and
determine baseline EAVs by multiplying the baseline hydrocarbon reserves with the composition of the baseline hydrocarbon reserves,
correct the baseline EAVs for a leakage factor,
determine advance EAVs by discounting the baseline EAVs using the leakage factor, for a set time interval, and
use the advance EAVs as the EAVs for determining the number of CEATs to be issued.

20. The system of claim 17,
wherein the CEATs are non-fungible tokens, and
wherein the at least one processor is further configured to:
convert the CEATs to fungible tokens, and
provide the fungible tokens to an owner of the hydrocarbon well.
